(19) United States
(12) Patent Application Publication
(10) Pub. No.: US 2018/0019616 A1
(43) Pub. Date: Jan. 18, 2018

(54) AUTOMOBILE POWER DISTRIBUTION APPARATUS

(71) Applicants: AutoNetworks Technologies, Ltd., Yokkaichi, Mie (JP); Sumitomo Wiring Systems, Ltd., Yokkaichi, Mie (JP); SUMITOMO ELECTRIC INDUSTRIES, LTD., Osaka-shi, Osaka (JP)

(72) Inventor: Hiromichi Yasunori, Yokkaichi, Mie (JP)

(21) Appl. No.: 15/554,622

(22) PCT Filed: Feb. 23, 2016
(86) PCT No.: PCT/JP2016/055233

§ 371 Date: Aug. 30, 2017

(30) Foreign Application Priority Data
Mar. 6, 2015 (JP) 2015-044814

(51) Int. Cl. B60R 16/03; H04B 7/26

(52) U.S. Cl. CPC H02J 50/05; B60R 16/03; H02J 50/10; H04B 7/26

(57) ABSTRACT

An automobile power distribution apparatus includes: a first wireless apparatus that includes a first wireless power supply unit, is disposed in an engine room, and receives a supply of power from a battery disposed in the engine room; a second wireless apparatus that includes a second wireless power supply unit and is disposed in a vehicle interior; and a power distribution apparatus configured to supply power supplied to the second wireless apparatus to an electrical device disposed in the vehicle interior. The first and second wireless power supply units are configured to perform wireless power supply from the first wireless apparatus to the second wireless apparatus, and the first and second wireless apparatuses are disposed so as to be near a partition between the engine room and the vehicle interior, or to be in contact with the partition.

### CROSS-REFERENCE TO RELATED APPLICATIONS

This application is the U.S. national stage of PCT/JP2016/055233 filed Feb. 23, 2016, which claims priority of Japanese Patent Application No. JP 2015-044814 filed Mar. 6, 2015.

### TECHNICAL FIELD

The present invention relates to a power distribution apparatus that enables electrical connection between spaces separated by a partition in an automobile, such as an automobile interior and an engine room.

### BACKGROUND

FIG. 4 shows an example of a conventional automobile power distribution apparatus. A battery 2 is connected to a relay box 3 in an engine room 1. The relay box 3 is connected to an electrical connection box 6 disposed in a vehicle interior 5 via a wire harness 4 in which many power source supply wires are bundled.

Many electrical devices are connected to the electrical connection box 6. Needed power is supplied from the battery 2 to the electrical devices via the relay box 3, the wire harness 4, and the electrical connection box 6.

Also, the needed power is supplied from the relay box 3 to electrical devices in the engine room 1 as well.

An ECU 7 is disposed in the engine room 1, and the ECU 7 controls the operations of electrical devices disposed in the engine room 1. Also, the ECU 7 is connected to an ECU 8 disposed in the vehicle interior 5 via a wire harness 9, and based on the communication with the ECU 8, the ECU 7 performs control such that the electrical devices in the engine room 1 operate in cooperation with the electrical devices in the vehicle interior 5.

The ECU 8 disposed in the vehicle interior 5 performs control such that the electrical devices in the vehicle interior 5 cooperate with the electrical devices in the engine room 1 based on communication with the ECU 7.

The wire harnesses 4 and 9 are inserted into an open hole formed in a partition 10 between the engine room 1 and the vehicle interior 5. In order to ensure air-tightness and water-tightness between the engine room 1 and the vehicle interior 5, a grommet 10a through which the wire harnesses 4 and 9 are inserted is fit into the open hole.

With the above-described power distribution apparatus, rainwater in the engine room 1 enters the vehicle interior 5 in some cases through the wire harnesses 4 and 9 since the grommet 10a through which the wire harnesses 4 and 9 are inserted is attached to the open hole in the partition 10.

In automobiles of recent years, the number of wires bundled as wire harnesses have been increasing along with an increase in electrical devices that are used. For this reason, the diameters of the wire harnesses increase, which makes it difficult to perform a task of bending the wire harnesses during routing and makes the task of routing complicated.

Also, it is not preferable to increase the diameter of the open hole formed in the partition 10 along with an increase in the diameters of the wire harnesses. Thus, there is a limit to the number of wires that are bundled as wire harnesses.

JP 2013-27069A discloses a grommet that has a waterproofing function. However, the waterproofing function does not reliably act in some cases. Also, since the diameter of the wire harness differs for each vehicle type, the grommet corresponding to that diameter needs to be designed and manufactured for each vehicle type. This increases the cost of parts.

It is an object of the present invention to provide an automobile power distribution apparatus that can reliably prevent entry of rainwater into a vehicle interior.

### SUMMARY

According to an aspect of the present invention, an automobile power distribution apparatus includes: a first wireless apparatus that includes a first wireless power supply unit, is disposed in an engine room, and receives a supply of power from a battery disposed in the engine room; a second wireless apparatus that includes a second wireless power supply unit and is disposed in a vehicle interior; and a power distribution apparatus configured to supply power supplied to the second wireless apparatus to an electrical device disposed in the vehicle interior. The first and second wireless power supply units are configured to perform wireless power supply from the first wireless apparatus to the second wireless apparatus, and the first and second wireless apparatuses are disposed so as to be near a partition between the engine room and the vehicle interior, or to be in contact with the partition.

According to this configuration, power can be supplied from a battery to an electrical device in a vehicle interior without using a wire harness that penetrates through a partition.

In the above-described automobile power distribution apparatus, it is preferable that the first wireless apparatus and the second wireless apparatus respectively include a first wireless communication unit and a second wireless communication unit, and the first and second wireless communication units are configured to wirelessly transmit and receive communication signals between an electrical device disposed in the engine room and the electrical device in the vehicle interior.

According to this configuration, communication between an electrical device in the engine room and an electrical device in the vehicle interior is possible without using a wire harness that penetrates through a partition.

In the above-described automobile power distribution apparatus, it is preferable that the first wireless apparatus and the second wireless apparatus are disposed at mutually-opposing positions on both sides of the partition, and a portion of the partition that is interposed between the first wireless apparatus and the second wireless apparatus is composed of a non-metal portion.

With this configuration, wireless power supply and wireless communication between the first wireless apparatus and the second wireless apparatus are stabilized.

In the above-described automobile power distribution apparatus, it is preferable that the first and second wireless power supply units are disposed at mutually-opposing positions on both sides of the partition, the first and second wireless communication units are disposed at mutually-opposing positions on both sides of the partition, and the partition includes through holes at a position between the first and second wireless power supply units and a position between the first and second wireless communication units.

With this configuration, wireless power supply and wireless communication between the first wireless apparatus and the second wireless apparatus are stabilized.

In the above-described automobile power distribution apparatus, it is preferable that the first wireless apparatus includes a first communication control unit that is interposed between the electrical device in the engine room and the first wireless communication unit and is configured to transmit and receive a communication signal, and the second wireless apparatus includes a second communication control unit that is interposed between the electrical device in the vehicle interior and the second wireless communication unit and is configured to transmit and receive a communication signal.

With this configuration, communication between the electrical device in the engine room and the first wireless communication unit is managed by the first communication control unit, and communication between the electrical device in the vehicle interior and the second wireless communication unit is managed by the second communication control unit.

According to another aspect of the present invention, an automobile including an automobile power distribution apparatus is provided. The automobile includes a body having an engine room, a vehicle interior, and a partition between the engine room and the vehicle interior, the automobile power supply apparatus includes: a first wireless apparatus that includes a first wireless power supply unit, is disposed in the engine room, and receives a supply of power from a battery disposed in the engine room; a second wireless apparatus that includes a second wireless power supply unit and is disposed in the vehicle interior; and a power distribution apparatus configured to supply power supplied to the second wireless apparatus to an electrical device disposed in the vehicle interior, the first and second wireless power supply units are configured to perform wireless power supply from the first wireless apparatus to the second wireless apparatus, and the first and second wireless apparatuses are disposed so as to be near the partition or to be in contact with the partition.

### Advantageous Effects of Invention

According to the automobile power distibution apparatus of the present invention, it is possible to reliably prevent entry of rainwater into the vehicle interior.

### BRIEF DESCRIPTION OF DRAWINGS

FIG. 1 is a schematic diagram showing an automobile power distribution apparatus according to an embodiment.

FIG. 2 is a block diagram showing a first wireless apparatus and a second wireless apparatus.

FIG. 3 is a perspective view showing a partition between a first wireless apparatus and a second wireless apparatus.

FIG. 4 is a schematic diagram showing a conventional automobile power distribution apparatus.

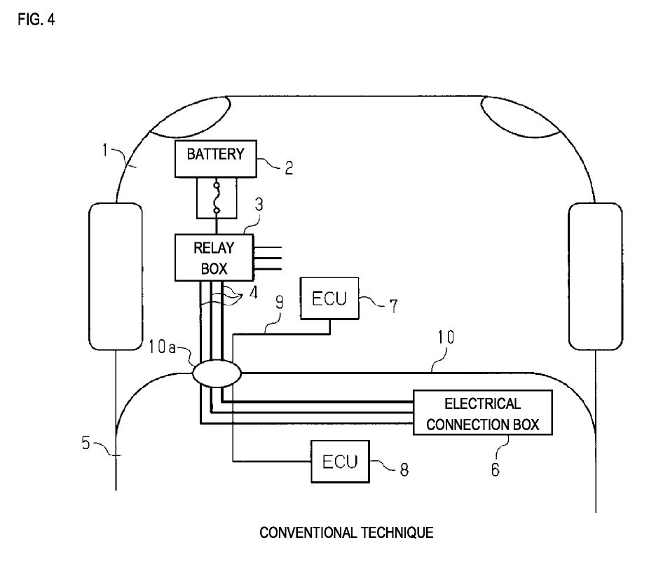

### DETAILED DESCRIPTION OF PREFERRED EMBODIMENTS

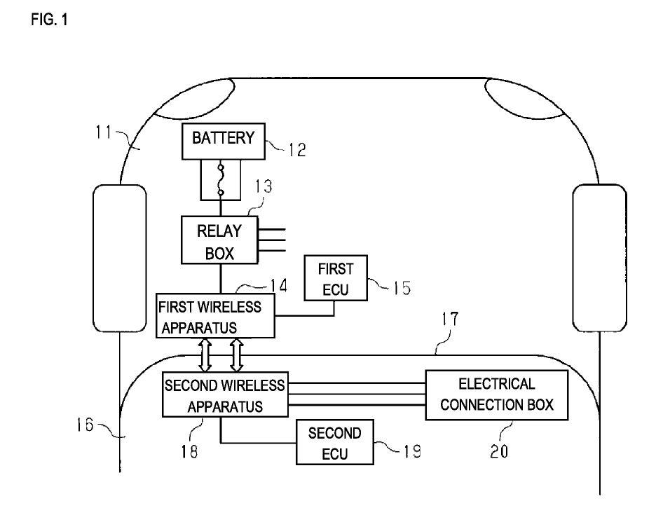

Hereinafter, an embodiment of an automobile power distribution apparatus will be described with reference to the drawings. As shown in FIG. 1, in an engine room 11, a battery 12 is connected to a relay box 13. Output power of the battery 12 is supplied from the relay box 13 to a first wireless apparatus 14. Needed power is supplied from the relay box 13 to electrical devices in the engine room 11 as well.

A first ECU 15 is disposed in the engine room 11. The first ECU 15 controls the operations of the electrical devices disposed in the engine room 11 and performs transmission and reception of communication signals with the first wireless apparatus 14.

In the engine room 11, the first wireless apparatus 14 is disposed so as to be near the partition 17 that separates the engine room 11 and the vehicle interior 16 or to be in contact with the partition 17.

In the vehicle interior 16, a second wireless apparatus 18 is disposed so as to be near the partition 17 or to be in contact with the partition 17, at a position opposing the first wireless apparatus 14 on the other side of the partition 17. The first wireless apparatus 14 can wirelessly supply power supplied from the battery 12 to the second wireless apparatus 18, and can transmit and receive various communication signals with the second wireless apparatus 18.

A second ECU 19 that is disposed in the vehicle interior 16 and a power distribution apparatus (in this embodiment, an electrical connection box 20) are connected to the second wireless apparatus 18. The power supplied to the second wireless apparatus 18 is supplied to the electrical connection box 20, and that power is furthermore supplied to many electrical devices disposed in the vehicle interior 16.

The second ECU 19 communicates with the first ECU 15 via the first and second wireless apparatuses 14 and 18 and controls the electrical devices in the engine room 11 and the electrical devices in the vehicle interior 16.

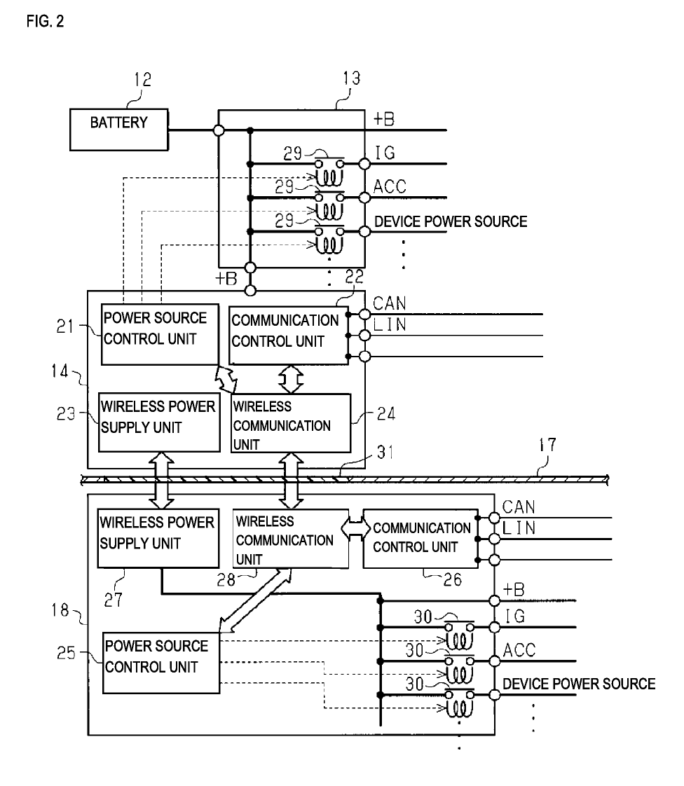

FIG. 2 shows configurations of the first and second wireless apparatuses 14 and 18. A power source is supplied from the battery 12 to the first wireless apparatus 14 via the relay box 13. The first wireless apparatus 14 includes a power source control unit 21, a communication control unit 22, a wireless power supply unit 23, and a wireless communication unit 24. The second wireless apparatus 18 also similarly includes a power source control unit 25, a communication control unit 26, a wireless power supply unit 27, and a wireless communication unit 28.

The power source control unit 21 of the first wireless apparatus 14 controls the switching on and off of relays 29 in the relay box 13 based on control signals output from the wireless communication unit 24.

The relay box 13 supplies power supplied from the battery 12 to the electrical devices in the engine room 11. Also, via the relays 29, the relay box 13 supplies power to an ignition device that needs power when performing an operation of switching on an ignition switch, an accessory device to which power is supplied at a time other than when performing the operation of switching on the ignition switch, a lighting device, an alarm, engine-related devices, and the like.

Accordingly, the switching on and off of the supply of power to the devices is controlled by the power source control unit 21 controlling the switching on and off of the relays 29.

The communication control unit 22 of the first wireless apparatus 14 is connected to communication devices such as the first ECU 15, a device that performs CAN communication, and a device that performs LIN communication, and the communication control unit 22 operates as a buffer between these devices and the wireless communication unit 24.

The wireless communication unit 24 of the first wireless apparatus 14 can perform two-way communication using a wireless communication scheme such as NFC or Transferjet, for example, with the wireless communication unit 28 of the second wireless apparatus 18.

The wireless power supply unit 23 of the first wireless apparatus 14 can perform wireless power supply to the wireless power supply unit 27 of the second wireless apparatus 18. In other words, in the present embodiment, the wireless power supply unit 23 operates as a power transmission unit and the wireless power supply unit 27 operates as a power reception unit. Examples of wireless power supply schemes that can be employed in the present invention include a magnetic induction scheme and an electrical field coupling scheme.

The power supplied to the wireless power supply unit 27 is supplied via the relays 30 to electrical devices in the vehicle interior 16, such as an ignition device that needs power when performing an operation of switching on an ignition switch, an accessory device to which power is supplied at a time other than when performing the operation of switching on the ignition switch, a door lock device, and a seat adjustment device.

The power source control unit 25 of the second wireless apparatus 18 controls the switching on and off of the relays 30 based on control signals output from the wireless communication control unit 28. Accordingly, the switching on and off of the supply of power to the devices is controlled by the power source control unit 25 controlling the switching on and off of the relays 30.

The communication control unit 26 of the second wireless apparatus 18 is connected to communication devices such as the second ECU 19, a device that performs CAN communication, and a device that performs LIN communication, and the communication control unit 26 operates as a buffer between these devices and the wireless communication unit 28.

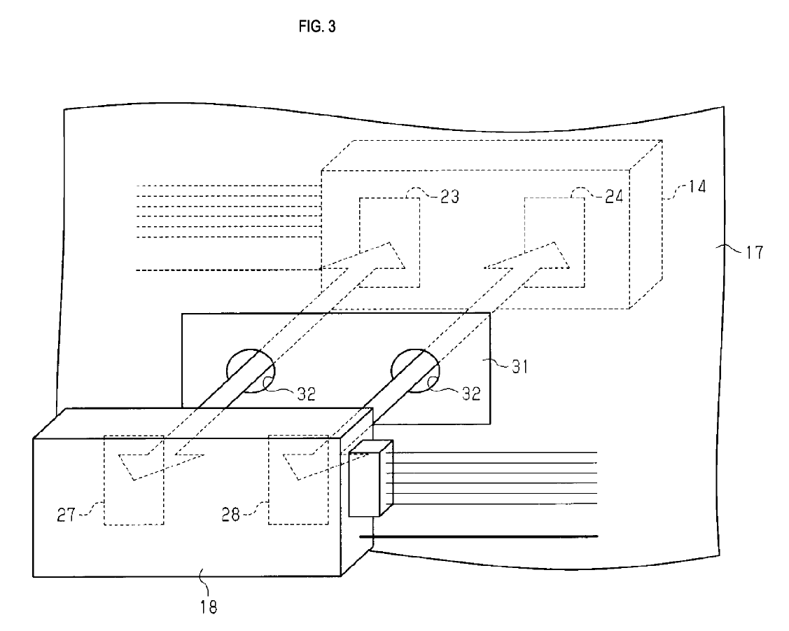

As shown in FIG. 3, a non-metal portion 31 such as a synthetic resin plate is provided in the partition 17 between the first wireless apparatus 14 and the second wireless apparatus 18 and prevents wireless power supply and wireless communication between the first wireless apparatus 14 and the second wireless apparatus 18 from being inhibited.

In order to further improve the wireless power supply efficiency and the communication efficiency, the non-metal portion 31 may include through holes 32 at a position interposed between the wireless power supply units 23 and 27 and at a position interposed between the wireless communication units 24 and 28. It is also possible to provide only the through holes 32 in the partition 17 without providing the non-metal portion 31.

In the case where the partition 17 includes the through holes 32, it is possible to prevent the entry of rainwater into the vehicle interior 16 from the engine room 11 by attaching the first and second wireless apparatuses 14 and 18 on both surfaces of the partition 17 so as to cover the through holes 32.

Next, effects of the automobile power distribution apparatus according to the above-described embodiment will be described.

The power supplied from the battery 12 is supplied to the devices in the engine room 11 via the relay box 13, which is controlled by the power source control unit 21.

The power supplied from the battery 12 is also supplied to the first wireless apparatus 14 via the relay box 13, and is used for wireless power supply from the wireless power supply unit 23 of the first wireless apparatus 14 to the wireless power supply unit 27 of the second wireless apparatus. Then, the power is supplied to the devices in the vehicle interior 16 from the wireless power supply unit 27.

The communication signals output from the first ECU 15 and the other devices in the engine room 11 are transmitted from the communication control unit 22 of the first wireless apparatus 14 to the wireless communication unit 24, the wireless communication unit 28 of the second wireless apparatus 18, and furthermore to the communication control unit 26, and are transferred from the communication control unit 26 to the second ECU 19 and the other devices.

Similarly, the communication signals output from the second ECU 19 and the other devices in the engine room 16 are transmitted from the communication control unit 26 of the second wireless apparatus 18 to the wireless communication unit 28, the wireless communication unit 24 of the first wireless apparatus 14, and furthermore to the communication control unit 22, and are transferred from the communication control unit 22 to the first ECU 15 and the other devices.

The above-described automobile power distribution apparatus exhibits the following effects.

(1) The power source can be supplied from the battery 12 in the engine room 11 to the electrical devices in the vehicle interior 16 via the wireless power supply units 23 and 24.

(2) There is no need to form an open hole to be penetrated by a wire harness in the partition 17 that separates the engine room 11 and the vehicle interior 16. Accordingly, it is possible to prevent the entry of rainwater into the vehicle interior 16 from the engine room 11.

(3) Since there is no need to form the open hole, there is no need to prepare grommets for each vehicle type. There is also no need to form open holes with different diameters for each vehicle type.

(4) Since the wire harness does not penetrate an open hole, there is no need to bend the wire harness near the open hole. Accordingly, it is possible to easily perform the task of routing the wire harnesses that extend from the first wireless apparatus 14 and the second wireless apparatus 18 near the partition 17.

(5) The communication signals between the electrical devices in the engine room 11 and the electrical devices in the vehicle interior 16 can be transmitted via the wireless communication units 24 and 28. Accordingly, there is no need for a wire harness for transmitting communication signals to penetrate the partition 17.

(6) In the case where a portion between the first wireless apparatus 14 and the second wireless apparatus 18 in the partition 17 is composed of the non-metal portion 31, it is possible to further stabilize the wireless power supply and the wireless communication between the first wireless apparatus 14 and the second wireless apparatus 18.

(7) In the case where the partition 17 includes the through holes 32 at a position interposed between the wireless power supply units 23 and 27 and a position interposed between the wireless communication units 24 and 28, it is possible to further stabilize the wireless power supply and wireless communication.

The above-described embodiment may be modified as follows.

The relay 30 may be provided in a relay box or the like outside of the second wireless apparatus 18, instead of inside of the second wireless apparatus 18.

The above-described embodiment is intended to be an example, and the present invention is not limited to the above-described embodiment. Various substitutions, alterations, and modifications can be performed on the disclosed exemplary embodiment without departing from the gist and scope of the present invention. For example, there is a possibility that the subject matter of the present invention exists in fewer than all of the characteristics of the specific disclosed embodiment. For this reason, the claims are incorporated in the detailed description, and each claim itself asserts a separate embodiment. The scope of the present invention is intended to encompass all substitutions, alterations, and modifications, as well as all equivalents thereto, in the scope of the claims.

1. An automobile power distribution apparatus, comprising:
a first wireless apparatus that includes a first wireless power supply unit, is disposed in an engine room, and receives a supply of power from a battery disposed in the engine room;
a second wireless apparatus that includes a second wireless power supply unit and is disposed in a vehicle interior; and
a power distribution apparatus configured to supply power supplied to the second wireless apparatus to an electrical device disposed in the vehicle interior,
wherein the first and second wireless power supply units are configured to perform wireless power supply from the first wireless apparatus to the second wireless apparatus, and
the first and second wireless apparatuses are disposed so as to be near a partition between the engine room and the vehicle interior, or to be in contact with the partition.

2. The automobile power distribution apparatus according to claim 1, wherein
the first wireless apparatus and the second wireless apparatus respectively include a first wireless communication unit and a second wireless communication unit, and the first and second wireless communication units are configured to wirelessly transmit and receive communication signals between an electrical device disposed in the engine room and the electrical device in the vehicle interior.

3. The automobile power distribution apparatus according to claim 2, wherein
the first wireless apparatus and the second wireless apparatus are disposed at mutually-opposing positions on both sides of the partition, and a portion of the partition that is interposed between the first wireless apparatus and the second wireless apparatus is composed of a non-metal portion.

4. The automobile power distribution apparatus according to claim 2, wherein
the first and second wireless power supply units are disposed at mutually-opposing positions on both sides of the partition, the first and second wireless communication units are disposed at mutually-opposing positions on both sides of the partition, and the partition includes through holes at a position between the first and second wireless power supply units and a position between the first and second wireless communication units.

5. The automobile power distribution apparatus according to claim 2, wherein
the first wireless apparatus includes a first communication control unit that is interposed between the electrical device in the engine room and the first wireless communication unit and is configured to transmit and receive a communication signal, and the second wireless apparatus includes a second communication control unit that is interposed between the electrical device in the vehicle interior and the second wireless communication unit and is configured to transmit and receive a communication signal.

6. An automobile comprising an automobile power distribution apparatus, wherein
the automobile comprises a body having an engine room, a vehicle interior, and a partition between the engine room and the vehicle interior,
the automobile power supply apparatus comprises:
a first wireless apparatus that includes a first wireless power supply unit, is disposed in the engine room, and receives a supply of power from a battery disposed in the engine room;
a second wireless apparatus that includes a second wireless power supply unit and is disposed in the vehicle interior; and
a power distribution apparatus configured to supply power supplied to the second wireless apparatus to an electrical device disposed in the vehicle interior,
the first and second wireless power supply units are configured to perform wireless power supply from the first wireless apparatus to the second wireless apparatus, and
the first and second wireless apparatuses are disposed so as to be near the partition or to be in contact with the partition.

7. The automobile power distribution apparatus according to claim 3, wherein the first wireless apparatus includes a first communication control unit that is interposed between the electrical device in the engine room and the first wireless communication unit and is configured to transmit and receive a communication signal, and the second wireless apparatus includes a second communication control unit that is interposed between the electrical device in the vehicle interior and the second wireless communication unit and is configured to transmit and receive a communication signal.

8. The automobile power distribution apparatus according to claim 4, wherein the first wireless apparatus includes a first communication control unit that is interposed between the electrical device in the engine room and the first wireless communication unit and is configured to transmit and receive a communication signal, and the second wireless apparatus includes a second communication control unit that is interposed between the electrical device in the vehicle interior and the second wireless communication unit and is configured to transmit and receive a communication signal.
